(19) United States
(12) Patent Application Publication
(10) Pub. No.: US 2018/0191212 A1
(43) Pub. Date: Jul. 5, 2018

(54) Rotary electric machine with a rotor that limits magnetic flux losses, notably electric motor

(71) Applicants: IFP Energies nouvelles, Rueil-Malmaison (FR); MAVEL S.r.l., PONT SAINT MARTIN (IT)

(72) Inventors: Wissam DIB, SURESNES (FR); Fabien DESARNAUD, ACHERES (FR); Luca FAVRE, Valpelline (IT); Davide BETTONI, Settimo Vittone (IT)

(21) Appl. No.: 15/738,477

(22) PCT Filed: Jun. 28, 2016
(86) PCT No.: PCT/EP2016/064958

§ 371 Date: Dec. 20, 2017

(30) Foreign Application Priority Data
Jun. 29, 2015 (FR) 1556066

(51) Int. Cl. H02K 1/27

(52) U.S. Cl. CPC H02K 1/2773; H02K 15/03

(57) ABSTRACT

The present invention relates to an electric machine comprising a rotor (10) and a stator (12), the said rotor being formed of a rotor body (18) with a stack of laminations (16) and placed on a rotor shaft (14), the said laminations comprising housings (40) to house magnetic-flux generators (20) and polar expansions (42) situated between the external (36) and the internal (38) edge of the said laminations.

According to the invention, the polar expansions (42) are connected by a connecting bridge (48) to the internal edge (38) of the said laminations.

The present invention relates to a rotary electric machine comprising a rotor housed in a stator and more particularly to an electric motor.

In general, the rotor is formed of a rotor body bearing magnetic-flux generators, such as permanent magnets, and is supported by a rotor shaft.

This rotor is generally housed inside a stator which bears electric windings (or armature windings) making it possible to generate a magnetic field making it possible to drive the rotation of the rotor in association with the magnetic field generated by the magnets.

As is known, the magnets are placed in evenly circumferentially distributed closed radial housings extending all along the axial dimension of the rotor body.

These housings thus between them delimit radial polar expansions which allow channeling of the magnetic flux coming from the magnets.

This arrangement, while satisfactory, does nevertheless have not-insignificant drawbacks.

Specifically, the magnetic flux is not completely channeled by the polar expansions and there are still flux losses at the external periphery of the rotor and more particularly at the external ends of these expansions.

Also, there are still magnetic flux losses at the connection between the polar expansions and the rotor shaft.

Because of these various losses, the electric machine is unable to achieve the required performance.

It is therefore necessary to alter the sizing of the rotor and/or to increase the generation of magnetic flux of the magnets in order to achieve the desired performance.

The present invention seeks to overcome the aforementioned drawbacks by using an electric machine in which the flux losses at the rotor are minimized.

To this end, the present invention relates to an electric machine comprising a rotor and a stator, the said rotor being formed of a rotor body with a stack of laminations and placed on a rotor shaft, the said laminations comprising housings to house magnetic-flux generators and polar expansions situated between the external and the internal edge of the said laminations, characterized in that the polar expansions are connected by a connecting bridge to the internal edge of the said laminations.

The laminations may comprise a connecting surface connecting the bridge and the internal edge.

The bridge may have a circumferential dimension that is smaller than the circumferential dimension of the polar expansion.

The bridge may have a circumferential dimension corresponding to approximately 10% of the circumferential dimension of the polar expansion.

The bridge may have a heightwise dimension corresponding to approximately 10% of the height measured between the external and internal edge of the said laminations.

The laminations may comprise an air space between two successive polar expansions and facing the housing.

The other features and advantages of the invention will now become apparent from reading the description which will follow, which is given solely by way of nonlimiting illustrative example and to which are appended:

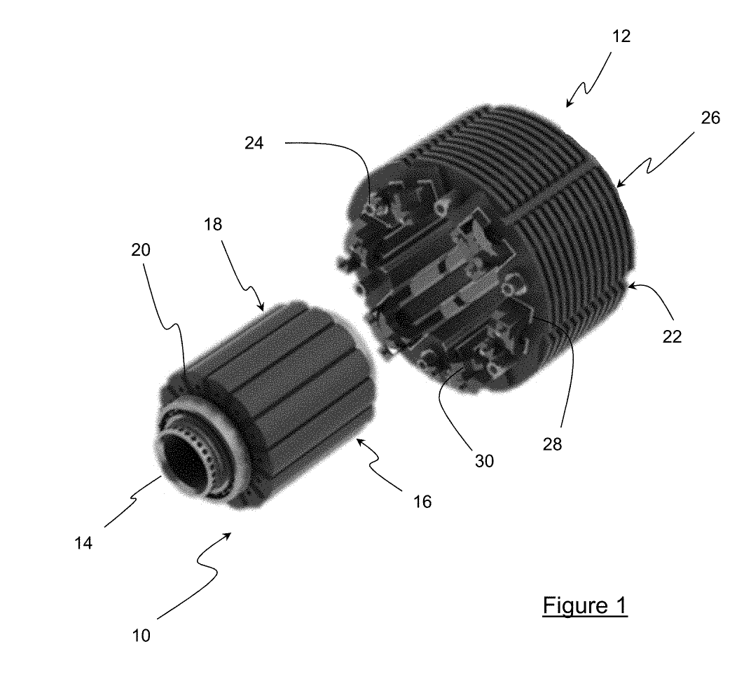

FIG. 1 which is a perspective view of the rotor and of the stator of the electric machine according to the invention,

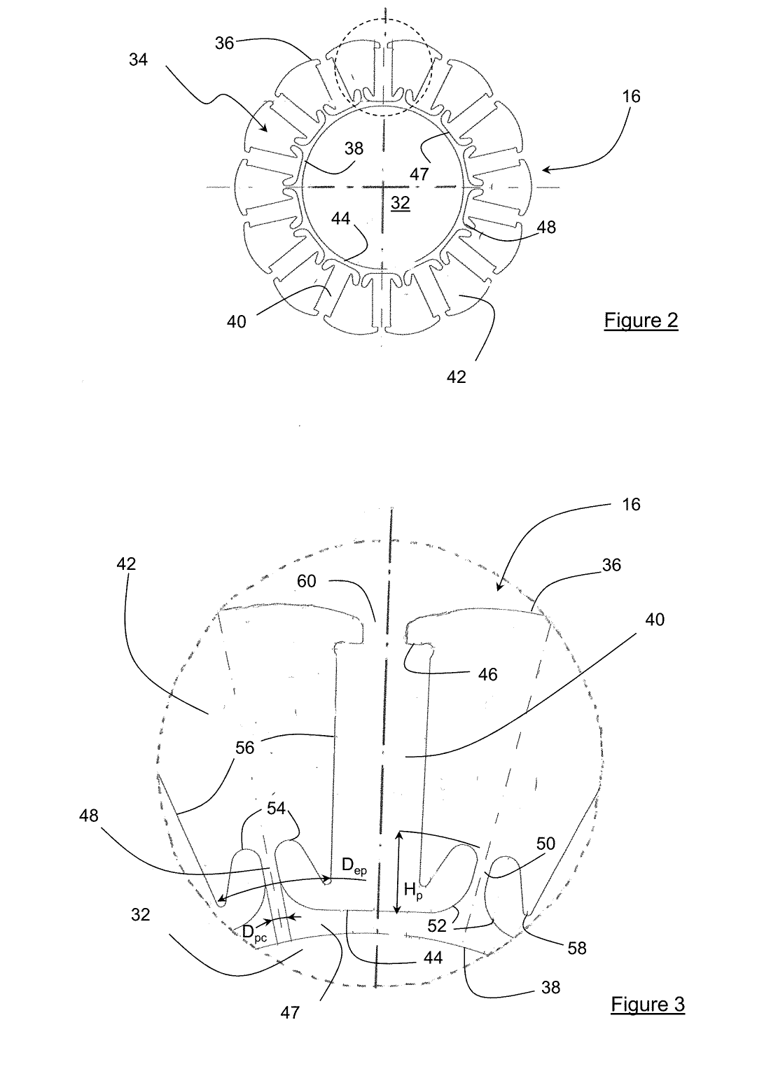

FIG. 2 which is a schematic view of an element of the rotor of FIG. 1, and

FIG. 3 which is a view on a larger scale of a detail of the rotor according to the circle A in FIG. 2.

As illustrated in FIG. 1, a rotary electric machine, in this instance an electric motor, comprises a rotor 10 and a stator 12 which, when assembled, are nested one inside the other coaxially, leaving the rotor free to rotate.

The rotor comprises, in a way known per se, a shaft 14 on which is placed a stack of identical planar ferromagnetic laminations 16, which are assembled to one another by any known means to form a rotor body 18.

This rotor bears magnetic-flux generators, in this instance permanent magnets 20, which, in the example illustrated, are in the form of bars of length substantially equal to the length of the stack of laminations.

The stator also comprises a stack of identical planar ferromagnetic laminations 22 which are joined together by any known means, such as threaded through-bolts 24, to form a tubular stator body 26.

The annular periphery of the stator body comprises a plurality of radial slots of substantially rectangular cross section 28 which are open towards the central part of this stator and extend along the entire periphery of the tubular stator. These slots are designed to house the armature windings 30 which are fixed thereto by any known means.

Reference is now made additionally to FIGS. 2 and 3 which illustrate the configuration of a rotor lamination 16.

This lamination has a substantially annular configuration with a central bore 32 that houses the rotor shaft, and an annular planar peripheral surface 34 with an external peripheral edge 36 and an internal peripheral edge 38.

The annular planar surface bears a succession of substantially rectangular radial housings 40 which are evenly circumferentially distributed over this surface to house permanent magnets. These housings thus between them delimit radial polar expansions 42.

The housings have a lower edge 44 some distance from the internal edge 38 of the planar peripheral surface and an upper edge 46 some distance from the external edge 36 of this planar peripheral surface.

The polar expansions are connected to a connecting surface 47 connecting the internal edge 38 and the bottom 44 by a connecting bridge 48 that has a circumferential dimension D_{pc} smaller than the smallest circumferential dimension Dₑₚ of the polar expansion and of a radial height Hₚ corresponding to approximately 12% of the height of the planar surface 34 measured between the edges 36 and 38.

For preference, the circumferential dimension D_{pc} is approximately 10% of that of Dₑₚ.

Referring more specifically to FIG. 3, the bridge 38 comprises a radial strip 50 with a curved connecting portion 52 connecting this strip to the internal edge 44 of the housings with which it is contiguous.

Advantageously, this bridge comprises two convex surfaces 54 allowing this bridge to be connected to the radial edges 56 of the polar expansion thereby forming a snout 58 in the direction of the housing.

As can be seen in the figures, this bridge makes it possible to form inverted T-shaped housings in which the horizontal bar of the T is formed by the internal edge 44 and the convex surfaces 54 of two adjacent polar expansions and in which the vertical bar is delimited by the radial edges 56 of these polar expansions and the external edge 46 of the housing.

As best illustrated in FIG. 3, the circumferential dimension D_{pc} is considered at the strip 50, the circumferential dimension Dₑₚ is considered at the tip of the snouts 58, and the height Hₚ is considered between the top of the convex surface 54 and the internal edge 44 of the housing 40.

Advantageously, the zone comprised between the external peripheral edge 36 and the external edge 46 of the housing comprises a space 60 referred to as the air space.

Once the laminations have been stacked and joined together to obtain the desired length of the rotor body by juxtaposing the housings and the polar expansions with one another, the permanent magnets are slide into the cavity thus formed by the housings and fixed by any known means.

The rotor shaft is then mounted in the rotor body, then the assembly is housed in the stator to create an electric machine with the necessary components, such as the commutator, the connectors, etc.

When the electric machine is in operation and thanks to the small circumferential dimension and small height of the bridge 48, this bridge soon becomes saturated with magnetic flux and flux losses are therefore limited.

In addition, the air space 60 between the polar expansions interrupts the transmission of magnetic flux between two adjacent expansions, and this can only limit flux losses.

Of course, it is within the competence of a person skilled in the art to design the bridge to take account of various constraints, such as the centrifugal force of the rotor, the magnetic force originating from the magnets and the force of magnetic attraction between the rotor and the stator.

1. Electric machine comprising a rotor and a stator, the rotor being formed of a rotor body with a stack of laminations and placed on a rotor shaft, the laminations comprising housings to house magnetic-flux generators situated between the external and the internal edge of the laminations, wherein the polar expansions are connected by a connecting bridge to the internal edge of the laminations.

2. Electric machine according to claim 1, wherein the laminations comprise a connecting surface connecting the bridge and the internal edge.

3. Electric machine according to claim 1, wherein the bridge has a circumferential dimension (Dpc) that is smaller than the circumferential dimension (Dep) of the polar expansion.

4. Electric machine according to claim 1, wherein the bridge has a circumferential dimension (Dpc) corresponding to approximately 10% of the circumferential dimension (Dep) of the polar expansion.

5. Electric machine according to claim 1, wherein the bridge has a heightwise dimension (Hp) corresponding to approximately 10% of the height measured between the external and internal edge of the laminations.

6. Electric machine according to claim 1, wherein the laminations comprise an air space between two successive polar expansions and facing the housing.
